(19) United States
(12) Patent Application Publication
(10) Pub. No.: US 2016/0206135 A1
(43) Pub. Date: Jul. 21, 2016

(54) INFUSION MACHINE

(71) Applicant: TCONCEPT COMPANY S.P.R.L., Corroy-le-Grand (BE)

(72) Inventor: Luc VAN BELLEGHEM, Rixensart (BE)

(73) Assignee: TCONCEPT COMPANY S.P.R.L., Corroy-le-Grand (BE)

(21) Appl. No.: 15/023,600

(22) PCT Filed: Sep. 30, 2014
(86) PCT No.: PCT/EP2014/070944

§ 371 Date: Mar. 21, 2016

(30) Foreign Application Priority Data
Oct. 3, 2013 (BE) 2013/0659

(51) Int. Cl. A47J 31/44

(52) U.S. Cl. CPC A47J 31/4492

(57) ABSTRACT

The machine comprises: an infusion chamber including infusion water introduction means and rinsing means; means for conveying an infused liquid; means for receiving a capsule of a product to be infused, bearing infusion data; means for establishing a sealed communication between the infusion chamber and an infusion capsule by means of a communication opening; means for discarding the capsule from the chamber; means for recognizing the infusion data borne by an infusion capsule. The recognition means are disposed outside the path followed by the steam leaving the infusion chamber through the communication opening in the infusion chamber after the capsule has been discarded from the chamber. In this way, the recognition means are not contaminated.

The field of the invention is that of machines for infusing products for infusion of the type comprising tea, mint, camomile and other similar products.

To prepare infusions it is customary to take the dried leaves of an infusion product, grind them up if necessary and put them in sachets which are placed in a teapot, for example, before hot water is poured onto them to cause thermal shock and thus open up the product molecule and cause the colour and flavours to be released.

Unlike coffee machines in which hot water is required to pass through the coffee, in infusion machines a capsule of a product to be infused is placed in sealed communication with an infusion chamber. Hot water is injected into the capsule which enters the chamber. The product for infusion infuses and migrates into the infusion chamber, thereby forming the infusion space with the capsule before the infused beverage is emptied into a container for consumption.

The quality of the infusion essentially depends on two infusion data which are, on the one hand, the temperature of the water and, on the other hand, the duration of the infusion steps. The temperature of the water is supposed to produce the necessary thermal shock and the infusion time should not be too long so as not to cause the beverage to become too bitter.

For this reason, designers of infusion machines have proposed that the data that have to be complied with in order to obtain a good infusion should be provided on the infusion capsules, and the devices for recognising these data should be provided in the infusion machines in order to control the different parts of the machines accordingly.

The infusion data may be provided in numerous forms. They may take the form of a bar code, a colour code or even an electronic chip.

As the capsules are generally introduced into a chute before reaching their position of communication with the infusion chamber by gravity, the infusion machines currently on the market therefore comprise a chute in the top part of which, close to the insertion opening, there is provided a retractable slide on which the capsules rest so that a recognition means can capture the infusion data before the capsules are released, after the retraction or withdrawal of the slide, and are able to continue their downward journey into the position of communication with the infusion chamber. It should be noted that, with some machines, the capsules are placed directly in the position of communication with the chamber.

This is where the problem may arise that forms the basis of the invention according to the present application.

After a capsule has been ejected from the infusion machine, or after the capsule has been removed from the chamber and collected in a suitable compartment of the machine, there follows a process of using hot water to rinse the infusion chamber, which is open to the outside as there is no longer a capsule obstructing it. The hot rinsing water produces steam which rises in the machine, coming into contact with the means for recognising the infusion data which is at the top. This steam contaminates the recognition means, with a serious risk of erroneous data recognition. It will be noted that, even if the chamber is rinsed with cold water, the infusion still produces steam which is detrimental to data recognition.

It is this problem of contamination which the Applicant has sought to solve and as a result has proposed this invention.

To this end, the invention according to the present application relates to an infusion machine comprising:
an infusion chamber having
means for introducing water for infusion and rinsing,
means for conveying an infused liquid,
means for receiving a capsule of a product to be infused, bearing infusion data,
means for establishing a sealed communication between the infusion chamber and an infusion capsule by means of a communication opening,
means for discarding the capsule from the chamber,
means for recognising the infusion data borne by an infusion capsule,
   the machine being characterised in that the said recognition means are disposed outside the path followed by the steam leaving the infusion chamber through the communication opening in the infusion chamber after the capsule has been discarded from the chamber.

In any case, the recognition means of the machine according to the invention are no longer at the top of the machine, close to the insertion opening of the chute, if the machine is one which has such a chute.

As a result, the recognition means are also protected from the disruptive effect of light striking the top of the machine.

Preferably, with the machine being provided with a receiving chute for a capsule and the capsule receiving chute comprising a lower edge just above said communication means, the recognition means are arranged below this lower edge and, advantageously also, outside the casing of the chute, on the opposite side to the infusion chamber.

In the preferred embodiment of the machine according to the invention, the means for establishing a sealed communication between the infusion chamber and a capsule comprise a push member arranged to move towards the communication opening of the infusion chamber and bearing the means for recognising the infusion data.

When a capsule is in the position of communication with the infusion chamber, opposite its communication opening, and the filter membrane of the capsule is facing the chamber so that the water can then pass between the chamber and the capsule, these infusion data are captured by the push member, either before it begins its action of pushing the capsule, or during its movement of advancing the capsule, or after the advancing movement, when the capsule is in a stable position.

Advantageously, the push member is a piston.

Preferably, the means for recognising the infusion data are carried by the front end of the push member facing the infusion chamber if the machine according to the invention is adapted to receive capsules the infusion data of which are provided on their base opposite their filter membrane.

The means for recognising the infusion data, depending on the form in which the infusion data are provided on the capsules, comprise elements and components well known to the skilled man which will therefore require no further description here. However, it should be pointed out that these means may comprise photosensors, a chip reader, etc. The invention will be better understood from the following description of the preferred embodiment of the machine according to the invention, with reference to the appended drawings, wherein:

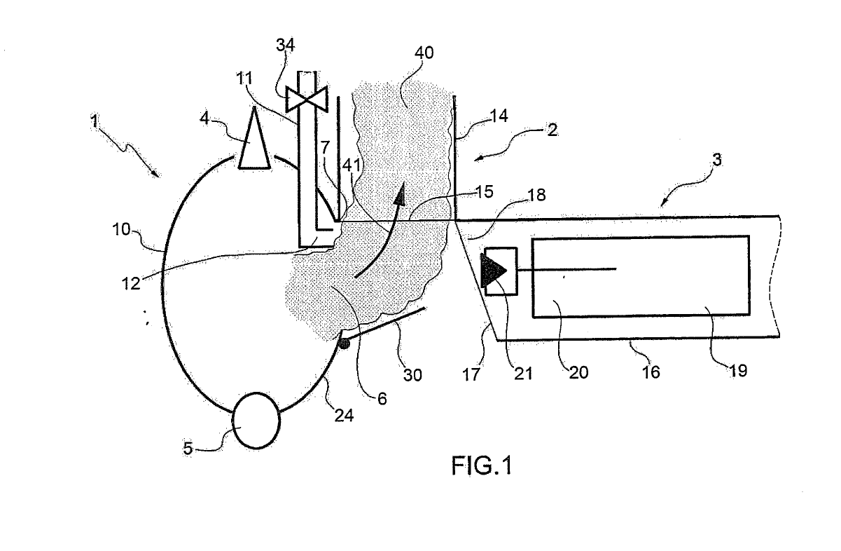

FIG. 1 is a highly schematic sectional view of the machine, without a capsule;

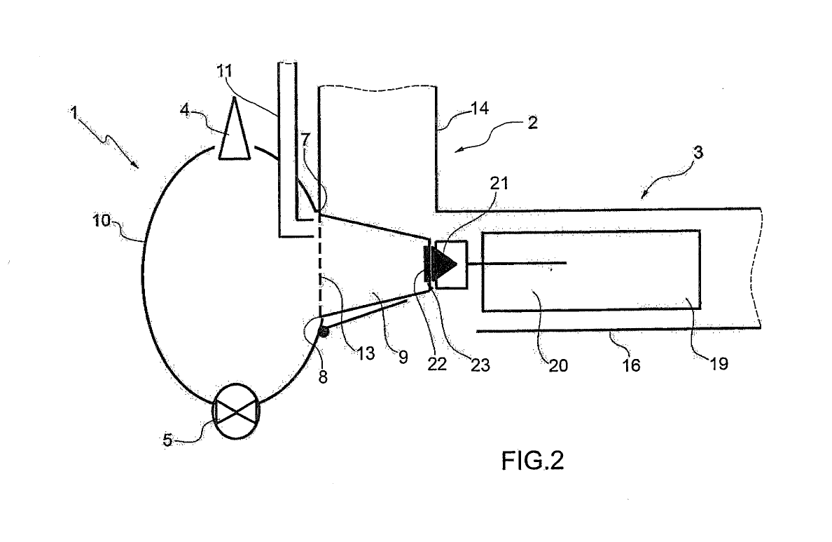

FIG. 2 is a sectional view of the machine in FIG. 1, with a capsule in sealed communication with the infusion chamber, and

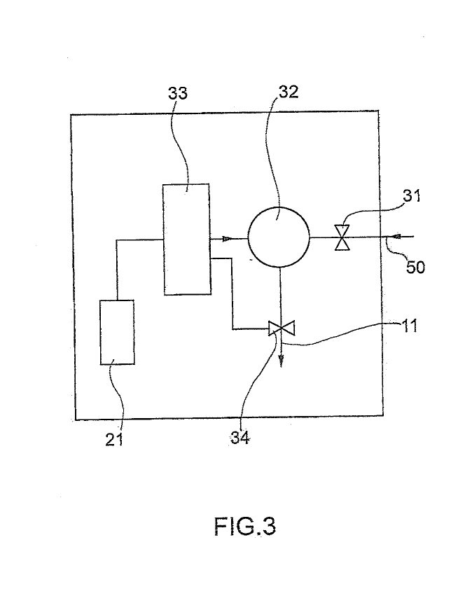

FIG. 3 is a block diagram of the means for controlling the infusion steps of the machine.

In a housing which, like its various components that are unconnected to the invention, is not shown here, the machine shown in the drawings comprises an infusion chamber 1, in this case a receiving and intake chute 2 for an infusion capsule, and a jack 3. In other machines, the capsule might be placed directly in the position of communication with the chamber, either manually or by means of a pivoting slide, for example.

The infusion chamber 1, with a wall 10, in this case ovoid in shape, although other shapes are perfectly possible, comprises at the top an intake nozzle for rinsing water 4, and at the bottom a flow valve for infused liquid 5. In the part which is in the centre here, substantially halfway up, the chamber 1 has an opening 6 for communicating with an infusion capsule 9, the edge 7 of this opening being shaped into an annular sealing lip ensuring sealed communication with the mating lip 8 of an infusion capsule 9 when it is pressed against the chamber. An intake tube 11 for infusion water is immersed, from the top of the machine, into the chamber, with an end spout 12 curving towards the opening 6 in order to spray the infusion water through the filter membrane 13 of a capsule 9, after they have been brought into sealed communication.

The receiving and intake chute 2 for an infusion capsule 9 comprises a casing wall 14, which is tubular in this case, with a lower edge 15 connected to the infusion chamber 1 by the top part of its opening, and connected to the housing 16 of the jack 2 by the upper part of its front edge 17 facing the chamber 1.

The jack 3 therefore comprises a housing 16, with a front edge 17 defining an opening 18 for the passage of a pushing piston 19, mounted to continue inside the housing, the front end 20 thereof bearing a device 21 for recognising the infusion data 22 which are borne here by the base 23 of the infusion capsules 9 that are designed to be used by the machine according to the invention.

The jack 3 is a jack for establishing a sealed communication between the chamber and a capsule 9 by advancing and pushing the capsule 9, by its base 22, by means of the front end 20 of the piston 19, until there is close co-operation between the lips 7, 8 of the opening 6 of the chamber 1 and the capsule 9, respectively.

A flap 30 acting as a seat for a capsule 9 during the infusion and onto which the capsule has been pushed by the piston 20 to provide sealed communication between the chamber 1 and the capsule 9 is jointed to the lower part 24 of the edge of the opening 6 of the chamber, in order to be able to pivot and be lowered so as to allow the capsule 9 to be ejected downwards by gravity after infusion. The flap is returned to its upper position of support for a capsule by a small push member.

The recognition device 21 carried by the piston 19 is arranged below the lower edge 15 of the chute 2, which is just above the jack for establishing communication.

In any case, this recognition device 21 is located outside the extension of the casing 14 of the chute 2. The infusion data captured by the recognition device will make it possible to control the infusion steps taking place in the machine.

To this end the machine comprises, at the water inlet 50, a valve 31, a heating device 32 connected to the water inlet by the valve 31, a controller 33 connected to the recognition device and adapted to control the heating temperature of the heating device 32 and the durations of the different infusion steps by controlling a valve 34 mounted on the water intake tube 11 submerged in the infusion chamber 1.

A particular infusion cycle will now be described, purely for guidance purposes.
1. In a first step of 8 to 10 seconds, two-thirds of the total volume, in this case 180 ml of hot water at the correct temperature T, are injected into the chamber through the tube 11.
2. Infusion is allowed to proceed through the filter membrane 13 of a capsule 9 for two-thirds of the total duration t of the infusion cycle.
3. Then one-third of the total volume of hot water is re-injected to homogenise the infusion.
4. It is then left to stand for a further one-third of the duration of the cycle t.
5. The flow valve 5 is opened in order to pour the infusion into a container.
6. The valve 5 is closed.
7. The capsule 9 is removed from the chamber.
8. The chamber 1 is rinsed by means of the nozzle 4, in this case with hot water.

Before the infusion cycle is carried out, a capsule 9 first has to be brought into communication with the chamber 1 and form an infusion space. To this end, it is placed in the chute 2, then it drops onto the flap 30 in its upper position, forming a seat. The base 23 of the capsule on which are provided the infusion data is thus opposite the recognition device 21 which captures the data and sends them to the controller 33 which controls various components of the machine, notably the jack 2, the valve 5, the nozzle 4 and the flap 30. The piston 19 pushes the capsule 9 against the chamber. The capsule 9 slides along the flap 30 until the lips 7, 8 of the chamber and the capsule cooperate in sealed manner. The infusion cycle can then begin.

In order to remove the capsule 9 from the chamber, the support flap 30 is allowed to pivot downwards, the capsule detaches itself from the chamber and is discarded by gravity. The support flap 30 constitutes what was referred to hereinbefore as the discarding means.

The rinsing of the infusion chamber with hot water then begins.

The steam 40 given off through the opening 6 of the chamber, steam from the rinsing water and/or steam from the infusion, rises in a curved path shown in FIG. 1 by the arrow 41 which concentrates the flow of rising steam inside the casing 14 of the chute 2 and which, above all, does not strike the jack 3 and the recognition device 21, which is outside the path of the steam, at the lower part of the machine.

In the infusion machine described here, there is an intake of infusion water into the chamber. It will be noted that, in some other machines, the infusion water is introduced directly into the infusion capsule.

1. Infusion machine comprising:
an infusion chamber having
means for introducing water for infusion and rinsing,
means for conveying an infused liquid,
means for receiving a capsule of a product to be infused, bearing infusion data,
means for establishing a sealed communication between the infusion chamber and an infusion capsule by means of a communication opening,
means for discarding the capsule from the chamber,
means for recognizing the infusion data borne by an infusion capsule,
the machine, wherein said recognition means are disposed outside the path of the steam leaving the infusion chamber through the communication opening in the infusion chamber after the capsule (9) has been discarded from the chamber.

2. Machine according to claim 1, wherein the capsule receiving means comprise a chute having a lower edge just above said communication means, and the recognition means are arranged below this lower edge.

3. Machine according to claim 2, wherein the recognition means are arranged outside the casing of the chute, on the opposite side to the infusion chamber.

4. Machine according to claim 1, wherein the means for establishing a sealed communication between the infusion chamber and a capsule comprise a push member arranged to move towards the communication opening of the infusion chamber and bearing the means for recognizing the infusion data.

5. Machine according to claim 4, wherein the push member is the piston of a jack.

6. Machine according to claim 1, adapted to receive capsules, the infusion data of which are provided on their base opposite their filter membrane, and wherein the means for recognizing the infusion data are carried by the front end of the push member facing the infusion chamber.

7. Machine according to claim 1, wherein the said discarding means comprise a pivoting support flap.

8. Machine according to claim 1, wherein the means for recognizing the infusion data are connected to a controller which controls various components of the machine.
